(19) United States
(12) Patent Application Publication
(10) Pub. No.: US 2017/0274517 A1
(43) Pub. Date: Sep. 28, 2017

(54) HAND-HELD CHISELLING MACHINE TOOL

(71) Applicant: HILTI AKTIENGESELLSCHAFT, Schaan (LI)

(72) Inventor: Eric MASCALL, München (DE)

(21) Appl. No.: 15/518,550

(22) PCT Filed: Oct. 13, 2015
(86) PCT No.: PCT/EP2015/073620

§ 371 Date: Apr. 12, 2017

(30) Foreign Application Priority Data
Oct. 16, 2014 (EP) 14189134.1

(51) Int. Cl. B25D 11/00; B25D 16/00

(52) U.S. Cl. CPC B25D 11/005; B25D 16/00; B25D 2250/131

(57) ABSTRACT

The invention relates to a hand-held chiselling machine tool comprising a motor and a pneumatic percussive mechanism that is driven by the motor. The user can select between at least two idling rotational speeds by means of a selector switch. In the chiselling mode, a motor control unit regulates a rotational speed of the motor to a nominal rotational speed. This nominal rotational speed cannot be set by the user, but is predetermined with regard to an optimal efficiency for said percussive mechanism. The motor control unit sets the rotational speed of the motor to the selected idling rotational speed when the percussive mechanism is idling. At least one of the selectable idling rotational speeds is greater than the nominal rotational speed.

### FIELD OF THE INVENTION

The present invention relates to a chiseling handheld power tool including a motor-driven pneumatic striking mechanism and a control method.

EP 1170095 A2 discloses a hammer drill including a pneumatic striking mechanism actuated by a motor. The striking mechanism has an exciter piston periodically force-excited by the motor along a working axis. An air spring configured by a pneumatic chamber between the exciter piston and a striker couples the striker to the exciter piston. An efficient operation of the striking mechanism is achieved during a nominal striking rate of the striker; the motor rotates at a corresponding nominal speed. The drill hammer detects an idle state of the striking mechanism. The idle state results typically if the user lifts the drill hammer off a substrate and hits the tool into the air. The drill hammer reduces the speed of the motor in the idle state. The drill hammer automatically increases the speed from the idle speed to the nominal speed if the user positions the drill hammer at the substrate using the tool. The user notices the reduction of the speed to the idle speed if the striking mechanism initially has only a low power output when positioning the tool until the motor is accelerated to the nominal speed.

### DISCLOSURE OF THE INVENTION

A chiseling handheld power tool according to the present invention has a motor and a pneumatic striking mechanism driven by the motor. The user can select between at least two idle speeds via a selector switch. A motor control unit adjusts a speed of the motor to a nominal speed in the chiseling mode. The nominal speed is not adjustable by the user and is specified in regard to an optimal efficiency of the striking mechanism. The motor control unit adjusts the speed of the motor to the selected idle speed if the striking mechanism is in the idle state. At least one of the selectable idle speeds is greater than the nominal speed. The handheld power tool has a high response behavior and a high degradation capacity. A different idle speed of the selectable idle speeds can be equal to the nominal speed. The striking mechanism starts slower and enables more precise work. For example, the handheld power tool has exactly two adjustable idle speeds, one being greater than the nominal speed and one equal to the nominal speed.

### BRIEF DESCRIPTION OF THE FIGURES

The subsequent description explains the present invention on the basis of exemplary embodiments and figures. In the drawing,

FIG. 1 shows a drill hammer.

The same or functionally equivalent elements are identified by the same reference characters in the figures, unless otherwise indicated.

### EMBODIMENTS OF THE INVENTION

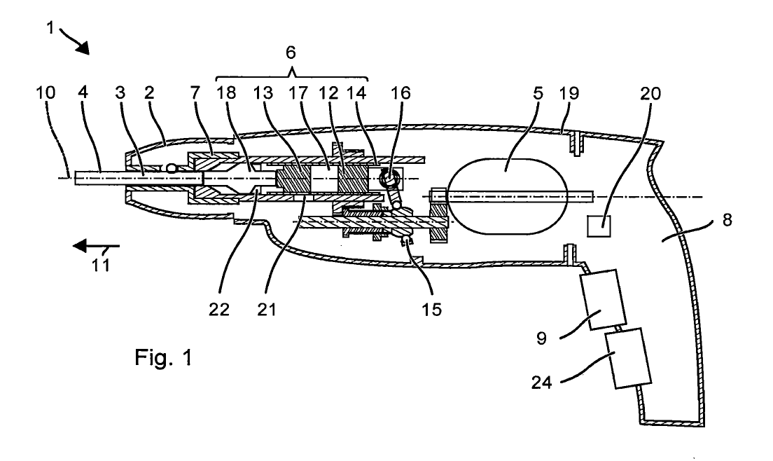

FIG. 1 schematically shows a hammer drill 1 as an example of a chiseling handheld power tool. Hammer drill 1 has a tool socket 2, into which one shank end 3 of a tool, for example a chisel 4, may be inserted. A motor 5 configures the primary drive of a hammer drill 1, which drives a striking mechanism 6 and a drive shaft 7. A battery pack or a mains line supplies motor 5 with power. The user may guide hammer drill 1 with the aid of a handle 8 and operate hammer drill 1 with the aid of a system switch 9. During operation, hammer drill 1 rotates chisel 4 continuously about a working axis 10 and, in so doing, is able to hammer the chisel 4 in striking direction 11 into a substrate along working axis 10.

Striking mechanism 6 is a pneumatic striking mechanism 6. An exciter piston 12 and a striker 13 are movably guided in a guide tube 14 in striking mechanism 6 along working axis 10. Exciter piston 12 is coupled via a wobble plate 15 to motor 5 and forced into a periodic linear movement. A wobble finger 16 connects wobble plate 15 to exciter piston 12. An air spring configured by a pneumatic chamber 17 between exciter piston 12 and striker 13 couples a movement of striker 13 to the movement of exciter piston 12. Striker 13 may directly strike against a back end of chisel 4 or with the aid of a substantially resting striking pin 18 indirectly transmit a portion of its pulse to chisel 4. Striking mechanism 6 and preferably further drive components are disposed within a power tool housing 19.

Motor control unit 20 monitors the speed of motor 5. The speed in the chiseling mode is adjusted to a nominal speed. Striking mechanism 6 is most efficient at the nominal speed. The movement of striker 13 has, caused by the mass of striker 13 and the coupling strength of the air spring, a natural periodicity, with which the periodicity of the movement of exciter piston 12 for the nominal speed is aligned.

Pneumatic chamber 17 vis-à-vis the environment is air-tightly sealed. An air inflow or air outflow because of leakage is by orders of magnitude smaller than the volume moved by exciter piston 12. Striking mechanism 6 has a valve 21 which enables an air exchange of the pneumatic chamber with the environment. Valve 21 is substantially a radial opening in guide tube 14, which vis-à-vis pneumatic chamber 17 is closed or opened by striker 13. During the chiseling operation, striker 13 is stopped in striking direction 11 by striking pin 18 or the tool in a strike point, which are inserted up to a stop 22 into striking mechanism 6 by the contact pressure of the user. The opening in striking direction 11 is offset vis-à-vis the strike point to such a degree that striker 13 covers the opening in the strike point. If there is no contact pressure, the tool and striking pin 18 may be positioned in an offset manner vis-à-vis stop 22 in striking direction 11. Striker 13 correspondingly slides beyond the strike point before it is stopped by striking pin 18. The opening is disposed along working axis 10 in such a manner that striker 13 frees the opening, therefore overlaps pneumatic chamber 17 with the opening along working axis 10. The air exchange of the environment with pneumatic chamber 17 decouples striker 13 from exciter piston 12. Striking mechanism 6 is in an idle state.

A motor control unit 20 is able to detect the idle state, for example, by the lower current consumption of motor 5. Motor control unit 20, for example, compares the current consumption to a first threshold value. Motor control unit 20 reduces the speed of the motor to an idle speed. Motor 5 maintains the idle speed, as long as the user continues to operate system switch 9. Motor control unit 20 increases the speed of motor 5 to the nominal speed, as soon as the user presses hammer drill 1 onto the substrate. During pressing, valve 21 is closed and striker 13 is, even though inefficiently, coupled to exciter piston 12. The current consumption of motor 5 increases above a second threshold value, which is smaller than the first threshold value.

Hammer drill 1 has a selector switch 24, via which the idle speed is adjusted. Selector switch 24, for example, has two positions. The idle speed is greater in the first position than in the second position. The first idle speed lies, for example, between 120% and 140% of the nominal speed. The first idle speed lies preferably at the threshold, at which pneumatic striking mechanism 6 is barely running. For a higher speed, exciter piston 12 moves too fast to excite striker 13 via the air spring. The second idle speed is, for example, equal to the nominal speed.

The idling may occur via other sensors instead of or in addition to the current detection. For example, a positioning sensor may detect the position of striking pin 18. If striking pin 18 abuts at stop 22, hammer drill 1 is in the chiseling mode; if striking pin 18 is displaced vis-à-vis stop 22, hammer drill 1 is in the idle state.

1. A chiseling handheld power tool comprising a motor,
a pneumatic chamber,
a pneumatic striking mechanism comprising an exciter piston force-excited by the motor, and a striker coupled to the exciter piston via the pneumatic chamber,
a selector switch for selecting an idle speed between at least one first idle speed and one second idle speed,
a motor control unit, which in a chiseling mode adjusts a speed of the motor to a nominal speed, and in an idle state adjusts the speed of the motor as a function of the selector switch selecting the idle speed, wherein the first idle speed is greater than the nominal speed.

2. The chiseling handheld power tool as recited in claim 1, wherein the first idle speed lies between 120% and 140% of the nominal speed.

3. The chiseling handheld power tool as recited in claim 1, wherein the second idle speed is equal to the nominal speed.

4. The chiseling handheld power tool as recited in claim 2, wherein the second idle speed is equal to the nominal speed.
